(19) United States
(12) Patent Application Publication
(10) Pub. No.: US 2025/0207860 A1
(43) Pub. Date: Jun. 26, 2025

(54) METHOD FOR REPAIRING A GLASS MELTING FURNACE

(71) Applicant: SAINT-GOBAIN CENTRE DE RECHERCHES ET D'ETUDES EUROPEEN, COURBEVOIE (FR)

(72) Inventors: Thibault CHAMPION, VILLELAURE (FR); Olivier CITTI, CAVAILLON CEDEX (FR); Thierry Claude CONSALES, PERNES LES FONTAINES (FR); Christian HIS, CAVAILLON (FR); Cyril LINNOT, LYON (FR); Thomas Patrick André PHILIPPE, LAGNES (FR); Franceline Marguerite Louise VILLERMAUX, AVIGNON (FR)

(21) Appl. No.: 18/849,898

(22) PCT Filed: Mar. 23, 2023
(86) PCT No.: PCT/EP2023/057475

§ 371 Date: Sep. 23, 2024

(30) Foreign Application Priority Data
Mar. 24, 2022 (FR) FR2202613

(51) Int. Cl. F27D 1/16; C03B 5/43

(52) U.S. Cl. CPC F27D 1/16; C03B 5/43; F27D 2001/161; F27D 2001/1615

(57) ABSTRACT

A method for hot repair of a region to be repaired (301, 302, 303) inside a glass melting furnace (10), the region to be repaired being at a temperature higher than 300° C., said method comprising the following steps: ⋅a) installing an interior shuttering (32i) in a use position, so as to produce a mold around the region to be repaired; ⋅b) filling the mold with a repair product (41). The interior shuttering has components that come into contact with the repair material during the repair, referred to as “shuttering elements”. All the shuttering elements are made of a ceramic. The region to be repaired is located on the side wall of the tank or in the superstructure.

### TECHNICAL FIELD

The present invention relates to a method for repairing a glass melting furnace. It also concerns a nozzle that can be used to carry out this method.

### PRIOR ART

FIG. 1 schematically shows a half-cross section of a glass melting furnace 10. A tank 12, a metallic structure 14 and a superstructure 16 can in particular be distinguished.

The tank 12, intended to contain the molten glass, has a vertical side wall 22 and a floor 24. The side wall 22 is conventionally made up of side tank blocks which extend over the entire height of the tank as far as an upper edge 25. The floor of the tank defines the substantially horizontal bottom of the tank and the side wall, which is substantially vertical, encircles the bottom. The assembly composed of tuckstones (if present), walls and crown is conventionally referred to as the “superstructure” of a glass melting furnace. The superstructure 16 is intended to close the furnace by covering the tank. It does not come into contact with the molten glass. It conventionally comprises, at its base, an intermediate layer 18 via which it rests on the metallic structure, a side wall 26 resting on the intermediate layer, and a crown 28. In a gas-fired furnace, the burners, which are not shown, are disposed in the side wall 26. The intermediate layer 18 comprises, and preferably is made up of, tuckstones 20.

The “interior” of the furnace is thus delimited by an inner surface 29 defined by a enclosure formed by the tank and the superstructure.

The molten glass, the vapors and the condensates are very corrosive. The refractory components are subject to significant wear.

The refractory components used, which are conventionally in the form of blocks or slabs, are components that are melted and cast or are obtained by sintering. They are selected depending on the location at which they are disposed, so as to withstand the local stresses and give the furnace a satisfactory service life. The selection is also guided by the need to not create faults that make the glass unusable; this would reduce the production yields.

In order to increase the service life of the furnace, the glass manufacturer is prompted to carry out repairs. A repair consists in filling an empty space resulting from the wear of the furnace with a repair material, which is to say in securing a repair material in a region initially occupied by a refractory material which has disappeared owing to the wear. This region is referred to as “region to be repaired”.

As illustrated in FIG. 2, a region to be repaired 30 may be “recessed”, which is to say in the form of a cavity 30₁, for example in the floor. It may also be “protruding”, which is to say be a region 30₂ in the continuation of an initially protruding block, for example a tuckstone. The region to be repaired may also pass through the enclosure of the furnace, placing the interior and the exterior of the furnace in fluidic communication. Such a through-region to be repaired may in particular result in leakages of molten glass in the tank. These leakages are dangerous and may result in the furnace being shut down. The region to be repaired 30₃ is an example of a through-region to be repaired.

A region to be repaired is therefore a space which is empty (devoid of refractory material) and delimited partially by one or more refractory components of the furnace and partially by a virtual envelope, in dotted line in FIG. 2, extending along the surface of said refractory component or components before they become worn.

To repair the furnace, as illustrated in EP0739861, conventionally shuttering is performed in order to mark said virtual envelope and produce, with the one or more refractory components, a mold which is able to contain the repair product before it hardens. The shuttering elements, for example in the form of flat or non-flat plates, are conventionally held by accessories in a use position in which they define said mold.

The shuttering has a part on the inside of a furnace, where the wear occurs. It may also have a part on the outside of the furnace when the wear has led to a passage through the enclosure of the furnace, in order to prevent the repair material escaping out of the furnace. The outer part of the shuttering is conventionally a plating. For the sake of clarity, those parts of the shuttering that are on the inside and on the outside of the furnace are referred to as “interior shuttering” and “exterior shuttering”, respectively.

“Hot” repair is a repair carried out at a temperature typically higher than 300° C. Hot repairing therefore only requires a limited reduction in temperature, referred to as “cooling down”, or even no reduction in temperature, and this considerably limits the time during which the furnace is not in use. The introduction of the shuttering elements into the furnace may, however, lead to them degrading under the effect of thermal shocks.

Furthermore, the interior of a furnace is not very accessible, and this makes it difficult to produce the interior shuttering for certain regions to be repaired. In particular, the introduction of the interior shuttering elements may require passages to be created through the enclosure of the furnace. Moreover, during a hot repair, no operator can enter the furnace. The interior shuttering must therefore sometimes be installed at a distance from the region to be repaired. The bulk and the weight of the interior shuttering elements can therefore considerably delay the production of the shuttering.

These constraints also make it very awkward to produce an interior shuttering of complex shape, in particular when the region to be repaired protrudes into the furnace.

The mold is then filled with repair product, conventionally by means of a pump. The repair product undergoes a sudden rise in temperature as it enters the mold, in particular resulting in a reduced ability to flow. It is therefore difficult to fill the mold uniformly.

Conventionally, the interior shuttering is made of metal and is cooled by circulation of water. After the repair product has hardened, the interior shuttering must therefore be removed, as the metal generates bubbling when it is in contact with the molten glass.

After the repair product has hardened, the removal of the shuttering makes room for the reconstructed refractory components. In general, however, the metallic shutterings do not make it possible to reconstruct the initial shapes if they were complex. The temperature can subsequently then be increased to resume operation of the furnace, during an operation referred to as “heating up”.

EP 0 739 861 B1 describes an example of a method for repairing glass melting furnaces, in particular the tank.

Products for repairing metal smelting furnaces also exist. The mechanical stresses in this application are, however, very different from those encountered in a glass furnace. In particular, the conditions for corrosion by a molten glass or by a molten metal are very different. Lastly, some impurities, which are tolerated in metal smelting furnaces, are unacceptable in the manufacture of glass. In particular, the refractory materials used in glass furnaces must not cause stones to be released by fragmentation or produce bubbles. A repair product intended for a metal smelting furnace is thus not, a priori, able to be used in a glass furnace, in particular in a zone in contact with the molten glass.

There is a continuing need for solutions for repairing a glass melting furnace that solve the aforementioned problems, in particular that allow the furnace to resume production quickly, without degrading the quality of the glass produced.

The present invention aims to at least partially meet this need.

### SUMMARY OF THE INVENTION

According to a first main aspect, the invention proposes a method for hot repair of a region inside a glass melting furnace, referred to as “region to be repaired”, at a temperature higher than 300° C., said method comprising the following steps:
a) installing an interior shuttering in a use position, so as to produce a mold around the region to be repaired;
b) filling the mold with a repair product, preferably by casting,
at least one part of the interior shuttering being made of a ceramic, which is preferably in the form of a ceramic matrix composite (CMC).

As will be seen in more detail in the rest of the description, the inventors have in particular discovered that a ceramic, in particular in the form of a CMC, does not substantially modify the quality of the glass manufactured when it comes into contact with the molten glass or with the corrosive vapors present in the furnace, and therefore does not require the interior shuttering to be removed when the repair has finished.

Furthermore, a ceramic, in particular in the form of a CMC
is lightweight, which makes it easier to manipulate,
can be easily shaped to complex geometries, thereby allowing precise adaptation to the configuration of the region to be repaired.

Additionally, a CMC withstands thermal shocks well, and this allows a hot repair without degradation of the shuttering elements when they are being introduced into the furnace.

The invention thus allows the furnace to resume production particularly quickly, without the repair adversely affecting the quality of the glass, and in particular without it adversely affecting the number of defects in the glass.

A method according to the invention may also comprise one or more of the following optional and preferred features:
the region to be repaired is located in the tank and/or in the superstructure;
said ceramic, which is preferably in the form of a CMC, is sintered;
said ceramic, which is preferably in the form of a CMC, consists of oxides for more than 90% of its weight;
in said ceramic, which is preferably in the form of a CMC, the total SiO₂+Al₂O₃+ZrO₂+Cr₂O₃ proportion is preferably greater than 80%, preferably greater than 90%, preferably greater than 95%, in percentage by weight based on the oxides;
said CMC comprises more than 20% and less than 80% by volume of fibers, the remainder consisting of the matrix;
said fibers are composed of oxides for more than 90%, preferably more than 99%, preferably 100%, in percentage by weight, preferably consist of an oxide;
said fibers preferably comprise more than 50% Al₂O₃ or SiO₂ or ZrO₂;
said fibers are arranged in the form of a woven fabric;
said matrix is composed of oxides for more than 90%, preferably more than 99%, preferably 100%, in percentage by weight;
said matrix comprises Al₂O₃ and/or SiO₂ and/or ZrO₂ and/or Cr₂O₃;
in said matrix, the total SiO₂+Al₂O₃+ZrO₂+Cr₂O₃ proportion is preferably greater than 80%, preferably greater than 90%, preferably greater than 95%, in percentage by weight based on the oxides;
said temperature of the region to be repaired is higher than 400° C., preferably higher than 500° C., preferably higher than 600° C., preferably higher than 700° C., preferably higher than 800° C., preferably higher than 900° C.;
step a) involves introducing into the furnace, through a passage, at least one element of said interior shuttering in a first configuration, and then deploying said shuttering element from the first configuration into a second configuration that is incompatible with an extraction of said shuttering element through said passage, which is to say such that the shuttering element has dimensions which, in the second configuration, prevent it from passing through the passage through the enclosure of the furnace;
said shuttering element is folded in the first configuration, and unfolded in the second configuration;
said passage
   results from wear of the furnace, or
   results from the dismounting of a burner and/or an electrode, or
   is made by an operator in order to introduce the shuttering elements into the furnace and is filled in again before operation of the furnace resumes;
step a) involves using at least one shuttering element having a concave shape, preferably having the form of a cavity which, in the use position, faces toward the inner surface of the furnace to produce said mold, in interaction with said inner surface;
step a) involves using at least one shuttering element having an undercut zone, which is to say a zone which, owing to its shape, impedes the extraction of the shuttering element after the repair product has hardened;
step a) involves using at least one shuttering element having the form of a flat or non-flat plate, the thickness of the plate being greater than 3 mm, preferably greater than 8 mm and/or less than 50 mm, preferably less than 40 mm, preferably less than 30 mm, preferably less than 20 mm, preferably less than 15 mm;
step a) involves shaping the interior shuttering such that the mold closely follows the region to be repaired, which is to say makes it possible to restore, after step b), the form of the furnace before it became worn;
the manufacture of said part of the interior shuttering made of a ceramic, which is preferably in the form of a ceramic matrix composite, includes taking an impression on a replica of that part of the furnace comprising the region to be repaired, before the wear of the furnace having resulted in the region to be repaired;
at least one element of said interior shuttering has the form of a part of the furnace that protruded into the furnace before said part disappeared owing to wear, in particular the form of a surface of a tuckstone that was initially exposed to the interior of the furnace;
the interior shuttering comprises a plate made of a ceramic, which is preferably in the form of a ceramic matrix composite, having two large faces substantially parallel to one another, the ratio of the surface area of a large face (in cm²) to the thickness (in cm, measured between the two large faces) being greater than 30 cm, preferably greater than 50 cm, preferably greater than 100 cm, preferably greater than 200 cm, preferably greater than 500 cm, preferably greater than 1000 cm, preferably greater than 2000 cm, and/or less than 250 000, preferably less than 200 000, preferably less than 150 000, preferably less than 100 000, preferably less than 50 000, preferably less than 10 000, preferably less than 8000, preferably less than 5000, each large face of the plate preferably having a surface area greater than 1000 cm², preferably greater than 1500 cm², preferably greater than 2000 cm², preferably greater than 2500 cm², and/or less than 10 000 cm², preferably less than 8000 cm², preferably less than 5000 cm²;
step a) involves using at least one shuttering element having a flat shape, which is to say a panel;
step a) involves using at least one shuttering element having a shape that goes along at least 3 faces, preferably at least 4 faces, or even 5 faces of a glass furnace refractory block, in particular a tuckstone;
step a) involves using at least one shuttering element having a shape that goes along a large face, which is for example rectangular, and two small faces disposed along opposite sides of the large face, for example along the two small sides or the two large sides of a large rectangular face;
step a) involves using accessories for holding the elements of the interior shuttering in the use position, said accessories, preferably having a tubular shape, being made of a ceramic, which is preferably in the form of a CMC, which is preferably identical to the ceramic, which is preferably in the form of a CMC, of the shuttering elements;
step a) involves positioning one or more tubes made of a ceramic, which is preferably in the form of a CMC, and/or one or more metallic rods, which are preferably cooled by means of water circulation, so as to hold the interior shuttering in place;
step a) involves using shuttering elements and, preferably, accessories, which are all made of a ceramic, which is preferably in the form of a CMC, such that the interior shuttering is entirely made of a ceramic, which is preferably in the form of a CMC;
step a) involves using shuttering elements and, preferably, accessories, which are all made of a ceramic, which is preferably in the form of a CMC, said shuttering elements and accessories preferably not being cooled, and in particular not being cooled by means of water circulation;
at least one element of the interior shuttering made of a ceramic, which is preferably in the form of a CMC, has through-holes and/or recesses disposed so as to be filled by the repair product during step b);
preferably the weight of a shuttering element, preferably the weight of more than 50% by number of the shuttering elements, preferably the weight of each of the shuttering elements is greater than 3 kg, preferably greater than 4 kg and/or preferably less than 50 kg, preferably less than 40 kg, preferably less than 30 kg, preferably less than 20 kg;
preferably the largest dimension of a shuttering element, preferably of more than 30% by number of the shuttering elements, preferably of more than 50% by number of the shuttering elements is greater than 400 mm, preferably greater than 600 mm and preferably less than 1600 mm, preferably less than 1400 mm;
step b) involves introducing the repair product into the region to be repaired by passing it through a passage resulting from wear of the furnace, which is optionally identical to the passage through which the interior shuttering elements were introduced;
step b) involves filling the mold by causing the repair product to pass through at least one nozzle, which preferably was introduced beforehand into the region to be repaired;
the nozzle is provided with radial discharge orifices through which the repair product passes, a radial direction being with respect to the supply direction of the nozzle;
the nozzle passes through the interior shuttering or a wall of the furnace, which in particular delimits the region to be repaired;
a first end of the nozzle bears against a surface of the interior shuttering, is preferably inserted in a recess in a surface of the interior shuttering, a second end of the nozzle being on the outside of the region to be repaired, inside or outside the furnace;
a first end of the nozzle bears against a inner surface of the furnace that defines the region to be repaired, is preferably inserted in a recess in a surface of the furnace that defines the region to be repaired, a second end of the nozzle being on the outside of the region to be repaired, inside or outside the furnace;
the one or more nozzles are made of a ceramic, which is preferably sintered and preferably has a similar, preferably identical chemical composition to that of the hardened, preferably sintered repair product;
the method comprises, after step b), a step 5) of hardening, preferably sintering the repair product introduced into the mold;
in step b), the hardened, preferably sintered repair product obtained consists of a plurality of constituents, the proportion of a constituent of the hardened, preferably sintered repair product, preferably any constituent of the hardened, preferably sintered repair product that is present in a proportion of greater than 5%, in percentage by weight based on the oxides
   differs by less than 20%, preferably by less than 10% from the proportion of said constituent in said ceramic, which is preferably in the form of a CMC, and/or
   differs by less than 20%, preferably by less than 10% from the proportion of said constituent in a region of the furnace that delimits the region to be repaired, and/or
   differs by less than 20%, preferably by less than 10% from the proportion of said constituent in said nozzle;
the interior shuttering and/or the nozzle are discarded in the region to be repaired after said repair, which is to say that they are not extracted before operation of the furnace resumes;
the method comprises, before step a), the following step:
if the region to be repaired is, at least partially, delimited by a surface of the tank of the furnace that is in contact with the bath of molten glass, at least partially draining said molten glass from the tank so as to expose said region to be repaired;
and, after step b), the following step:
introducing a glass composition to be melted into the tank, the temperature of the furnace being maintained in said region to be repaired throughout the steps of the method;
the method comprises, after exposing the region to be repaired, a step of rinsing the region to be repaired.

The invention also relates to a glass melting furnace comprising at least one region repaired by a method according to the invention.

According to a second main aspect, the invention proposes a repair product injection nozzle, in particular for a glass furnace, the nozzle comprising
a supply orifice through which the repair product is intended to enter the nozzle, and
an orifice for discharging the repair product from the nozzle, which is in fluidic communication with the supply orifice and leads to the outside of the nozzle via a discharge opening oriented along a discharge direction which is radial with respect to the axis of the nozzle.

A nozzle according to the invention may also comprise one or more of the following optional and preferred features:
the axis of the nozzle extends in the direction of the length of the nozzle;
the axis of the nozzle is parallel, preferably coincides with the axis of the supply orifice;
the nozzle is made of a ceramic, which preferably consists of oxides for more than 90% of its weight, preferably more than 95% of its weight, preferably more than 98% of its weight, preferably more than 99% of its weight, preferably more than 99.5% of its weight;
the proportion of a constituent of the nozzle, preferably any constituent present in a proportion of greater than 5%, in percentage by weight based on the oxides:
   differs by less than 20%, preferably by less than 10% from the proportion of said constituent in a region of the furnace that delimits the region to be repaired, and/or
   differs by less than 20%, preferably by less than 10% from the proportion of said constituent in the hardened, preferably sintered repair product;
the nozzle has more than 1, preferably more than 3, preferably more than 5, preferably more than 10, preferably more than 20 and/or less than 100, preferably less than 50 discharge orifices;
a discharge orifice, preferably each discharge orifice is a cylindrical hole, preferably of circular or oblong, preferably circular cross section;
the discharge openings of the discharge orifices are evenly distributed over at least a part of the outer surface of the nozzle, preferably over a cylindrical part of the outer surface of the nozzle;
the discharge opening of a discharge orifice, preferably of each discharge orifice, has an equivalent diameter greater than 8 mm, preferably greater than 10 mm and/or less than 50 mm, preferably less than 40 mm, preferably less than 30 mm, preferably less than 25 mm;
the nozzle has the overall shape of a tube, preferably closed off at one end, the axis of the nozzle being the axis of said tube;
the nozzle has a cylindrical overall shape, preferably of circular cross section, one end of the nozzle preferably being closed by an end wall;
the nozzle has a wall of substantially constant thickness, preferably greater than 5 mm, preferably greater than 7 mm, preferably greater than 10 mm and preferably less than 30 mm, preferably less than 25 mm, preferably less than 20 mm;
the nozzle has an equivalent inside diameter greater than 40 mm and preferably less than 200 mm, preferably less than 150 mm, preferably less than 100 mm.

In a hot repair method according to the invention, comprising steps a) and b), use is preferably made of at least one nozzle according to the invention for injecting the repair product.

In general, the invention proposes a method for repairing a region inside a glass melting furnace, referred to as “region to be repaired”, preferably at a temperature higher than 300° C., said method comprising the following steps:
a′) installing an interior shuttering in a use position, so as to produce a mold around the region to be repaired;
b′) filling the mold with a repair product, preferably by casting,
at least one part of the interior shuttering preferably being made of a ceramic, which is preferably in the form of a CMC,
a nozzle according to the invention being installed in step a′) in a supply position in which at least one discharge orifice, preferably each injection orifice leads into the region to be repaired, and at least one supply orifice, preferably each supply orifice, leads out of the region to be repaired, preferably out of the furnace.

With preference, in the supply position, one end of the nozzle, preferably the end of the nozzle opposite the supply orifice, bears against, preferably is fixed to a surface delimiting the region to be repaired, in particular that surface of the interior shuttering or that inner surface 29 of the furnace that is defined by the tank and the superstructure of the furnace. The fixing preferably results in said nozzle end being inserted into a recess made in the surface of the interior shuttering or in the inner surface of the furnace, the recess preferably having a complementary shape to said end.

With preference, in the supply position, the nozzle passes through a wall of the furnace, for example the side wall of the tank of the furnace, and preferably is fixed to the interior shuttering, or passes through the interior shuttering and preferably is fixed to a wall of the furnace.

The bearing, preferably the fixing of the nozzle advantageously contributes to the stiffness of the interior shuttering. The presence of the nozzle may also advantageously contribute to the strength of the repair, by anchoring the repair product after it hardens.

The nozzle is preferably discarded in the furnace after repair. It may thus contribute to the anchoring of the repair product. This in turn also makes the repair method easier.

With preference, a method according to the second main aspect of the invention is a repair method according to the first main aspect of the invention, and vice versa. In particular, step a′) may comprise one or more optional or non-optional features of a step a), and step b′) may comprise one or more optional or non-optional features of a step b).

The invention also relates to a method comprising the following steps:
2) preferably rinsing said region to be repaired;
3) optionally reducing the temperature in the furnace to a temperature higher than 300° C.;
4) implementing steps a) and b) or steps a′) and b′);
5) preferably, in particular when the method comprises a step 3), increasing and maintaining the temperature of the furnace between 900° C. and 1400° C. in order to sinter the repair product;
6) introducing a glass composition to be melted into the tank and, if said method comprises a step 3), increasing the temperature of the furnace up to an operating temperature resulting in the melting of said composition.

The method preferably comprises a step 2) of rinsing the region to be repaired.

In one embodiment, the method comprises a step 3) of reducing the temperature in the furnace to a temperature higher than 900° C. and lower than 1500° C., and a step 5) in which the furnace is maintained at a temperature ranging between 900° C. and 1400° C.

The method preferably comprises a step 5) in which said temperature is maintained for a period of time longer than 8 hours and shorter than 15 hours.

In a first particular embodiment, the region to be repaired is at least partially delimited by a surface of the tank of the furnace that is in contact with the bath of molten glass, and the method comprises, before step 2), the following step:
1) at least partially draining said molten glass from the tank, so as to completely expose said region to be repaired.

In a second particular embodiment, the region to be repaired is entirely delimited by a surface of the tank of the furnace that is not in contact with the bath of molten glass, and the method does not comprise a step 1).

### BRIEF DESCRIPTION OF THE FIGURES

Other features and advantages of the invention will emerge more clearly on examining the following description and with regard to the appended drawing, in which:

FIG. 1, described in the preamble, schematically shows a half-cross section of a glass melting furnace, before wear occurs;

FIG. 2 schematically shows the furnace from FIG. 1, after wear occurs;

FIG. 3 schematically shows a method according to the invention;

FIG. 4 schematically shows a partitioned region to be repaired;

FIG. 5 schematically shows an example of a nozzle according to the invention for feeding the repair product into the region to be repaired;

FIG. 6 schematically shows a first step for producing a shuttering, in one embodiment of the invention;

FIG. 7 schematically shows a second step for producing a shuttering, in the embodiment of the invention from FIG. 6;

FIG. 8 shows an example of a shuttering according to the invention;

FIG. 9 shows an example of an interior shuttering element having through-holes.

### DEFINITIONS

A “shuttering” is a part of the “mold” into which the repair product is introduced.

It results from assembling one or more “shuttering elements” and from positioning the one or more assembled shuttering elements in the “use position”. That part of the mold that is defined by the shuttering is supplemented by a part of the inner surface of the furnace so as to form the mold.

In addition to the shuttering elements, a shuttering comprises “accessories”, which are used to assemble the shuttering elements and fix them in position and are not in contact with the repair material during the repair. By contrast to the accessories, the shuttering elements are components which come into contact with the repair material during the repair.

The region to be repaired may be compartmentalized by means of partitions. A partition is considered to be a shuttering element.

A “passage” is a hole which passes through the enclosure of the furnace, thus placing the interior and the exterior of the furnace in communication.

The “equivalent diameter” of a surface is the diameter of a disk having the same area as this surface.

“Unshaped product” refers to a dry particulate mixture.

A product “made of a material” or “of a material” is understood to mean a product consisting of said material for more than 95%, more than 98%, preferably substantially 100%, of its weight.

A “refractory material” is understood to mean a material exhibiting a melting point higher than 1500° C. This definition is commonly employed by those skilled in the art and is cited in “Matériaux réfractaires et céramiques techniques (éléments de céramurgie et de technologie [Engineering refractory and ceramic materials (ceramurgy and technology components)]”, G. Aliprandi, published by Septima Paris, 1979. This publication also gives, on pages 297 to 301, examples of refractory materials, in particular oxides, carbides and nitrides.

The “glass transition temperature” of a glass is understood to mean the temperature at which said glass changes from the solid state to the viscous state. The glass transition temperature may be determined by differential thermal analysis (DTA). The glass transition temperature is the temperature at which said glass exhibits a viscosity substantially equal to 10¹² Pa·s. A glass is conventionally regarded as “in the solid state” at a temperature lower than its glass transition temperature.

A “hot binder” is understood to be a constituent exhibiting a melting point higher than 600° C. and capable of bonding together, after hardening under the effect of a drop in the temperature, particles with which it has been mixed.

“Maximum size” refers to the 99.5 (D_{99.5}) percentile of a powder, this percentile corresponding to the percentage by weight of 99.5% on the cumulative particle size distribution curve of the sizes of the particles of the powder, the sizes of the particles being categorized in increasing order. The particle size distributions and the maximum size can be determined using a laser particle sizer. The laser particle sizer may be a Partica LA-950 from Horiba.

“Impurities” are understood to be the unavoidable constituents, introduced inadvertently and inevitably with the raw materials or resulting from reactions with these constituents. The impurities are not necessary constituents, but merely tolerated constituents. Preferably, the amount of the impurities is less than 2%, less than 1%, less than 0.5%, indeed even substantially zero.

“Self-flowable under hot conditions” is understood to mean a repair product which is capable of spreading under its own inherent weight and of filling the mold without leading to segregation, within a temperature range between 300° C. and 1550° C. Segregation is considered to have occurred when the flow face of the product obtained after placement of the repair product and sintering exhibits a surface layer of milkiness which extends from said flow face over a depth of 3 mm or more. This surface layer of milkiness can easily be demonstrated after drying or sintering of the product, with sawing taking place in a plane perpendicular to the flow face.

AZS products are products, preferably electrofused products, the main constituents of which are alumina (Al₂O₃), zirconia (ZrO₂) and silica (SiO₂). In other words, alumina, zirconia and silica are the constituents having the highest proportions by weight. These products are highly suitable for the manufacture of glass furnaces. More particularly, the current AZS products are used primarily for the regions in contact with the molten glass and also for the superstructure of the glass furnaces. AZS products include, in particular, products sold by Saint-Gobain SEFPRO, such as ER-1681, ER-1685 or ER-1711.

When reference is made to ZrO₂ or to zirconia, it is to be understood as ZrO₂ and traces of HfO₂. This is because a little HfO₂, which is chemically indissociable from ZrO₂ in a melting process and which exhibits similar properties, is always present naturally in zirconia sources in proportions of generally less than 2%. Hafnium oxide is then not considered to be an impurity. The content of HfO₂ in the AZS particles is preferably less than 5%, less than 3%, less than 2%.

A “ceramic-matrix composite”, or “CMC”, is conventionally understood to be a ceramic composed of a textile made of ceramic stiffened by a ceramic matrix.

A “textile” is an assembly of fibers, possibly a yarn, in particular an assembly of yarns. The textile typically represents between 20% and 80% of the volume of a CMC, the remainder to 100% being the matrix.

In general, when reference is made to a percentage by volume in relation to an object, for example a CMC (for example a percentage of fibers) or the matrix of a CMC (like in the previous sentence), the volume under consideration is that of the object defined by its outer surface, which is to say that it includes the empty spaces inside the object.

A “fiber” is a filament of which the length is greater than 5 times its equivalent diameter. The “equivalent diameter” of a fiber is the diameter of a disk having the same surface area as its cross section at mid-length.

In a textile, the fibers may be assembled haphazardly, such as in a felt or a paper, or along one or more preferential directions, preferably in the form of yarns, which are themselves preferably in the form of one or more woven fabrics. A yarn of a textile may be
a “single yarn”, which is an assembly of fibers which, in cross section, comprises more than 10 and preferably less than 500 000 fibers, and the length of which is greater than 5 times the diameter, or
an “assembled yarn”, which is an assembly of single yarns which, in cross section, preferably comprises more than 2 and preferably less than 500 single yarns.

A textile may be in particular:
an organized structure of single or assembled fibers and/or yarns, in particular a knit or a woven fabric, or
a random structure of single or assembled fibers and/or yarns, for example a web, and/or of fibers not incorporated in the form of yarns, said random structure possibly being for example a paper or a felt, a random structure not being preferred.

A “woven fabric” is made up of a network of parallel warp yarns, and weft yarns passing transversely through said network.

A “knit” is made up of a network of yarns in the form of loops, possibly reinforced by one or more sets of yarns extending substantially parallel to one another, said one or more sets being entrapped in said loops.

A “mat” is made up of a set of parallel yarns.

A “ceramic” is understood to be a product which is neither metallic nor organic. Within the scope of the present invention, carbon is considered to be a ceramic product.

A “sialon”, SiAlON, is an oxynitride compound of at least one of the elements Si, Al and N, in particular a compound satisfying one of the following formulae:
-SiₓAl_{y}OᵤNᵥ, where:
   x is greater than or equal to 0, greater than 0.05, greater than 0.1 or greater then 0.2, and less than or equal to 1, less than or equal to 0.8 or less than or equal to 0.4,
   y is greater than or equal to 0, or greater than 0.1, greater than 0.3 or greater then 0.5, and less than or equal to 1,
   u is greater than 0, greater than 0.1 or greater then 0.2, and less than or equal to 1 or less than or equal to 0.7,
   v is greater than 0, greater than 0.1, greater than 0.2 or greater then 0.5, or greater than 0.7, and less than or equal to 1,
   x+y>0,
   with x, y, u and v being stoichiometric indices normalized with respect to the highest, which is made equal to 1;
MeₓSi₁₂₋₍ₘ₊ₙ₎Al₍ₘ₊ₙ₎OₙN₁₆₋ₙ, where 0≤x≤2, Me is a cation selected from the cations of lanthanides, Fe, Y, Ca, Li and their mixtures, 0≤m≤12, 0 ≤n≤12 and 0<n+m≤12, the SiAlON according to this formula being generally referred to as “α′-SiAlON” or “SiAlON-α′”.

Unless stated otherwise, all the percentages are percentages by weight based on the oxides. A proportion by weight of an element is expressed in the form of the most stable oxide.

“Include” or “comprise” or “have” or “exhibit” are not to be interpreted as limiting.

### DETAILED DESCRIPTION

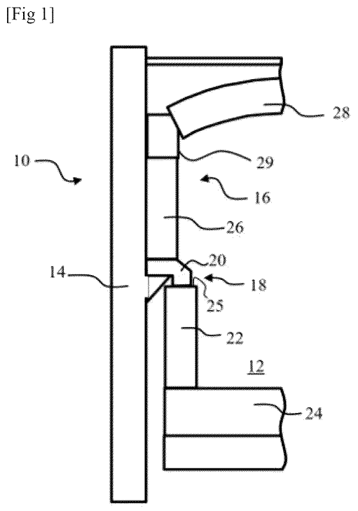

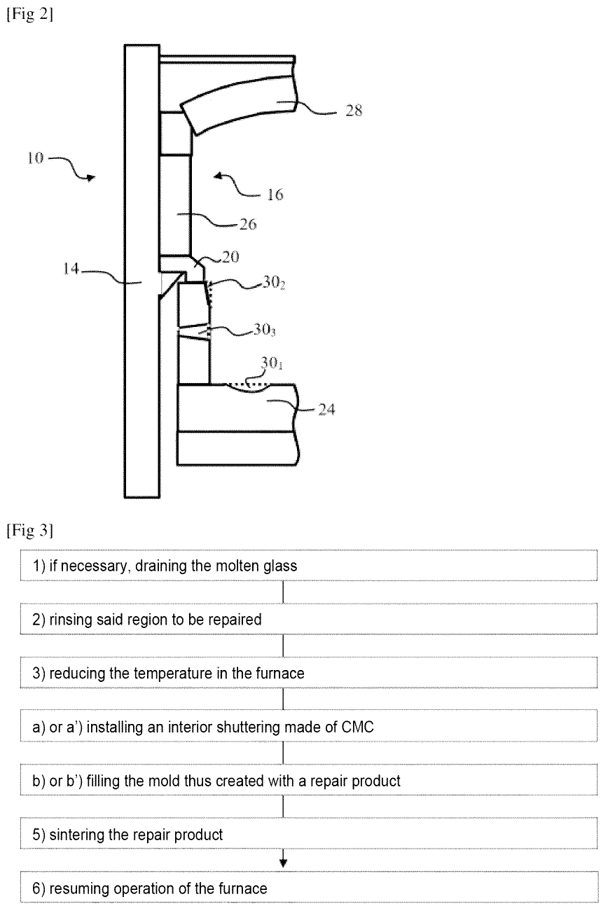

With FIGS. 1 and 2 having been described in the preamble, reference is made to FIG. 3.

### Hot Repair

A method according to the invention is used for the hot repair of a region of a glass melting furnace.

The region to be repaired 30 may be in particular located in the tank 12, preferably in the side wall 22 of the tank and/or in the superstructure 16, in particular in the intermediate layer 18 and/or in the side wall 26 of the superstructure.

The invention is particularly useful for repairing the side wall 22 of the tank or the superstructure. Specifically, it is then necessary to retain the repair product to avoid it flowing out by gravity. This is generally not a problem for the repair of the floor. The use of shuttering elements made of ceramic, in particular in the form of plates, and in particular made of a ceramic in the form of a CMC, advantageously makes it possible to produce a shuttering which does not need to be cooled. This shuttering can therefore be more lightweight (in particular if it is realized by thin plates). Moreover, because there is no cooling and because it can be left in place after repair, this shuttering can be installed very quickly and does not need to be dismounted. This in turn advantageously reduces the downtime of the furnace for the repair. Lastly, the shuttering may have a complex shape.

The region to be repaired may have the form of a through-cavity or blind cavity, for example a region which is recessed, notably owing to wear, which leads into the furnace, for example the tank.

In one embodiment, in particular for the repair of a tank initially containing a bath of molten glass in contact with the region to be repaired, the method comprises a step 1) of at least partially draining the molten glass from the tank so as to expose said region to be repaired.

The tank of the furnace is therefore at least partially drained of the molten glass it contains, until the region to be repaired is uncovered. The draining can be performed by any technique known to those skilled in the art.

For example, it is possible to discharge the molten glass from the furnace through passages made in the floor or through passages created by dismounting one or more electrodes or one or more burners.

Step 1) is optional for the repair of a region which is not in contact with the bath of molten glass.

In step 2), which is optional but preferred, the region to be repaired is rinsed, which is to say cleared of the glass residues, by any conventional technique. A product designed to increase the fluidity of the molten glass is preferably sprayed at least on the region to be repaired. The glass thus fluidified can be discharged from the furnace more easily. The fluidification product is preferably selected from sodium sulfate, sodium carbonate, sodium hydroxide and their mixtures.

In step 3), which is optional, the temperature in the furnace may be reduced to a temperature preferably greater than 400° C., preferably greater than 500° C., preferably greater than 600° C., preferably greater than 700° C., preferably greater than 800° C., preferably greater than 900° C., and preferably less than 1550° C., preferably less than 1500° C., or indeed less than 1450° C. or 1400° C.

In one embodiment, the repair product used in step b) contains a hot binder, and in step 3), the temperature in the furnace is reduced to a temperature at which the hot binder is not in the solid state. In particular, when the hot binder is a glass, the temperature in the furnace is reduced to a temperature that is still higher than the glass transition temperature of said glass. Said glass is preferably selected such that its glass transition temperature is between 600° C. and 1350° C., preferably between 900° C. and 1350° C., preferably between 1000° C. and 1300° C., preferably between 1150° C. and 1250° C.

In step 4), the repair product is put in place following steps a) and b).

In step a), the region to be repaired is delimited using a shuttering 32, so as to form, together with the furnace, a mold for the repair product.

The shuttering 32 comprises an interior shuttering 32i, which delimits the mold 36 on the inside of the furnace. The interior shuttering therefore extends along the dotted lines shown on the inside of the furnace in FIG. 2. The interior shuttering follows in particular the opening of the regions to be repaired 30₁ in the form of a cavity.

When the region to be repaired passes through the furnace, in particular the tank, such as the region to be repaired 30₃, the shuttering 32 preferably comprises an exterior shuttering, not shown, which delimits the exterior opening of the region to be repaired, via which it leads out of the furnace, and thus retains the repair product before it is hardened, preferably sintered.

According to the invention, at least one part of the interior shuttering, preferably all the interior shuttering, is made of a ceramic, which is preferably in the form of a CMC.

In one embodiment, at least one part of the exterior shuttering, or indeed all the exterior shuttering, is made of a ceramic, which is preferably in the form of a CMC.

With preference, in particular when the region to be repaired is, at least partially, delimited by a surface of the tank of the furnace, at least one part of the interior shuttering, preferably all the interior shuttering, and optionally of the exterior shuttering and/or of the accessories, is made of a ceramic, which is preferably in the form of a CMC, consisting of oxides for more than 90% of its weight, preferably for more than 95% of its weight, preferably for more than 98% of its weight, preferably for more than 99% of its weight, preferably for more than 99.5% of its weight. This advantageously improves the compatibility of the ceramic, in particular in the form of a CMC, with the molten glass during normal use of the furnace.

The exterior shuttering is preferably made of the same material as the possibly already existing plating. In one embodiment, the exterior shuttering is made of a ceramic in the form of a CMC, which is preferably identical to that of the interior shuttering.

It is possible to manufacture a ceramic, in particular in the form of a CMC, by any conventional process.

In particular, the ceramic may be manufactured by casting, pressing, vibrocasting, or melting methods. The shuttering elements made of ceramic may be obtained directly following these methods or be machined into blocks obtained following these methods.

Those skilled in the art will know to adjust the parameters of the method selected for manufacturing the ceramic, and in particular to determine the particle size of the raw materials, the water content during the shaping, and the sintering temperature if the ceramic is sintered.

The manufacture of a CMC may in particular comprise the following steps:
i) disposing, on or in a textile, a slurry able to form a ceramic matrix after consolidation;
ii) before or after step i), shaping the textile;
iii) consolidating the preform obtained after the preceding steps, preferably by drying and/or sintering, so as to form said matrix and obtain the CMC.

In step i), the textile is a set of fibers, preferably assembled in the form of yarns, with a yarn typically comprising several hundred to several thousand fibers. The fibers, preferably the yarns, preferably have a length greater than 50 mm, or indeed greater than 100 mm. In one embodiment, the fibers, preferably the yarns are arranged in the form of at least one woven fabric.

The textile may in particular have the form of a felt of disordered yarns or fibers, a mat, for example a mat consisting of yarns extending substantially parallel to one another (said yarns being referred to as “unidirectional fibers”), a knit, a woven fabric (which is to say a woven textile) or a stack of one or more felts and/or mats, and/or knits and/or woven fabrics.

The textile preferably has the form of a felt or a woven fabric or a mat or a stack of felt(s) and/or mat(s) and/or woven fabric(s). The stack of woven fabrics and/or mats can be produced such that the yarns of the various woven fabrics or mats substantially all extend in the same direction, or in 2, 3, 5, 5 or 6 different directions, in particular depending on the desired mechanical properties.

With preference, at least some, preferably all of said ceramic fibers of the textile, possibly assembled in the form of single and/or assembled yarns, are:
fibers comprising more than 95%, preferably more than 97%, preferably more than 98%, preferably more than 99%, preferably more than 99.5% by weight of oxides, and/or
fibers comprising more than 95%, preferably more than 97%, preferably more than 98%, preferably more than 99%, preferably more than 99.5% by weight of silicon carbide, and/or
fibers comprising more than 95%, preferably more than 97%, preferably more than 98%, preferably more than 99%, preferably more than 99.5% by weight of carbon.

With preference, the fibers of the textile comprise more than 95%, preferably more than 97%, preferably more than 98%, preferably more than 99%, preferably more than 99.5% by weight of oxides.

With preference, at least some, preferably all of said ceramic fibers are:
fibers comprising more than 95%, preferably more than 97%, preferably more than 98%, preferably more than 99%, preferably more than 99.5% by weight of oxides and having a chemical analysis such that SiO₂+Al₂O₃+ZrO₂>50%, preferably SiO₂+Al₂O₃+ZrO₂>60%, or indeed SiO₂+Al₂O₃+ZrO₂>70%, or indeed SiO₂+Al₂O₃+ZrO₂>80%, or indeed SiO₂+Al₂O₃+ZrO₂>90%, in percentage by weight based on the oxides, and/or
fibers comprising more than 95%, preferably more than 97%, preferably more than 98%, preferably more than 99%, preferably more than 99.5% by weight of oxides and having a chemical analysis such that SiO₂>70%, preferably SiO₂>80%, preferably SiO₂>90%, or indeed SiO₂>99%, in percentage by weight based on the oxides, and/or
fibers comprising more than 95%, preferably more than 97%, preferably more than 98%, preferably more than 99%, preferably more than 99.5% by weight of oxides and having a chemical analysis such that Al₂O₃>65%, preferably Al₂O₃>70%, or indeed Al₂O₃>80%, or indeed Al₂O₃>90%, or indeed Al₂O₃>95%, in percentage by weight based on the oxides.

With further preference, at least some, preferably all of the ceramic fibers are
fibers composed of alumina for more than 95%, preferably more than 98%, preferably more than 99%, preferably substantially 100% by weight, and/or
fibers composed of silica for more than 95%, preferably more than 98%, preferably more than 99%, preferably substantially 100% by weight, preferably composed of preferably amorphous for more than 95%, preferably more than 98%, and/or
fibers composed of mullite and corundum for more than 95%, preferably more than 98%, preferably more than 99%, preferably substantially 100% by weight, and/or
fibers composed of glass, preferably leached glass, and their mixtures for more than 95%, preferably more than 98%, preferably more than 99%, preferably substantially 100% by weight.

All the fibers preferably have the same composition.

The slurry can be disposed on or in the textile for example by impregnation. Said stack can be produced by pressing, or by vacuum forming, preferably after impregnation.

The manufacture of the slurry is well known to those skilled in the art. The slurry is conventionally a suspension, for example of aqueous base or an organic solvent, containing
ceramic particles and/or ceramic-particle precursors, which is to say compounds that transform into ceramic particles during manufacture of the CMC, and in particular during the hardening, in particular during sintering, and
optionally dispersants, plasticizers, lubricants, and/or temporary binders.

The composition of the slurry, the ceramic-particle or ceramic-precursor size distribution and the mineral filler of the slurry are adapted to the type of fibers and to the shaping technique. For example, the slurry may be disposed around or in the textile, in particular in the form of a direct lamination, by infusion, injection, infiltration or deposition, under atmospheric pressure or under higher pressure or by vacuum forming, at ambient temperature or at a higher temperature.

In step ii), the textile obtained, which is preferably impregnated with the slurry, is shaped. The shape desired is preferably the final shape of the CMC. In one embodiment, the shape may, however, be modified after hardening of the matrix, for example by machining or by deformation.

With preference, to produce the interior shuttering, the textile is shaped in such a way that the shape of the CMC is adapted such that, after installation of the shuttering, the repair material replaces solely the material that has been extracted by the wear, preferably replaces all the material that has been extracted by the wear. In other words, the shape is preferably determined such that, in the use position, the interior shuttering elements made of CMC follow the dotted lines in FIG. 2.

The shape can be conferred by producing, with the textile (before or preferably after introducing the slurry), an impression on a reproduction of the part to be repaired of the furnace before wear occurred. The mold is then a “negative” of the region to be repaired. For example, if the region to be repaired is a tuckstone, the CMC can be produced by depositing the textile, preferably in the form of a woven fabric or a superposition of multiple woven fabrics, on a replica of the tuckstone, before or after impregnation with the slurry but before consolidation, such that this textile closely follows the surface of the tuckstone at least in the region corresponding to the region to be repaired. The use of a ceramic, and in particular one in the form of a CMC, advantageously makes it possible to produce complex shapes, which may be non-developable ones, easily. The repair thus makes it possible to precisely reconstruct the initial profile of the inner surface of the furnace.

The CMC may be manufactured by superposing prepregs each consisting of a woven fabric impregnated with a slurry of ceramic particles. The prepregs are flexible so as to be able to assume the desired shape.

In step iii), the consolidation, preferably by sintering, is preferably carried out before the shuttering is installed, thereby making this installation easier.
In general, the characteristics of the ceramic, which is in particular in the form of a CMC, result from its process of manufacture.

With preference, said ceramic, which is preferably in the form of a CMC, has one or more of the following optional features:
the ceramic, which is preferably in the form of a CMC, is preferably sintered;
the ceramic, which is preferably in the form of a CMC, preferably has an open porosity, measured by imbibition, according to Archimedes' principle of buoyancy, of greater than 10%, preferably greater than 15% and less than 50%, preferably less than 45%, preferably less than 40%;
the ceramic is in the form of a CMC and preferably has an open porosity, measured by imbibition, according to Archimedes' principle of buoyancy, of greater than 25%, preferably greater than 30%;
the ceramic is not in the form of a CMC and preferably has an open porosity, measured by imbibition, according to Archimedes' principle of buoyancy, of less than 30%, preferably less than 25%;
the ceramic, which is preferably in the form of a CMC, is preferably made up of oxides for more than 90% of its weight, preferably more than 95% of its weight, preferably more than 98% of its weight, preferably more than 99% of its weight, preferably more than 99.5% of its weight;
the CMC preferably comprises more than 20%, preferably more than 25%, preferably more than 30%, preferably more than 40%, preferably more than 50%, preferably more than 60% and/or less than 80%, preferably less than 70% by volume of fibers;
the CMC comprises fibers, said fibers being composed of oxides for more than 90%, preferably more than 95%, preferably more than 97%, preferably more than 98%, preferably more than 99%, preferably more than 99.5% by weight;
at least some, preferably all of said ceramic fibers are:
   fibers comprising more than 95%, preferably more than 97%, preferably more than 98%, preferably more than 99%, preferably more than 99.5% by weight of oxides and having a chemical analysis such that SiO₂+Al₂O₃+ZrO₂>50%, preferably SiO₂+Al₂O₃+ZrO₂>60%, or indeed SiO₂+Al₂O₃+ZrO₂>70%, or indeed SiO₂+Al₂O₃+ZrO₂>80%, or indeed SiO₂+Al₂O₃+ZrO₂>90%, in percentage by weight based on the oxides, and/or
   fibers comprising more than 95%, preferably more than 97%, preferably more than 98%, preferably more than 99%, preferably more than 99.5% by weight of oxides and having a chemical analysis such that SiO₂>70%, preferably SiO₂>80%, preferably SiO₂>90%, or indeed SiO₂>99%, in percentage by weight based on the oxides, and/or
   fibers comprising more than 95%, preferably more than 97%, preferably more than 98%, preferably more than 99%, preferably more than 99.5% by weight of oxides and having a chemical analysis such that Al₂O₃>65%, preferably Al₂O₃>70%, or indeed Al₂O₃>80%, or indeed Al₂O₃>90%, or indeed Al₂O₃>95%, or indeed Al₂O₃>97%, or indeed Al₂O₃>98%, in percentage by weight based on the oxides;
the ceramic is in the form of a CMC and the matrix of the CMC is composed of oxides, or carbides and/or nitrides and/or sialons, in particular of the type of those described above, for more than 90%, preferably more than 95%, preferably more than 97%, preferably more than 98%, preferably more than 99%, preferably more than 99.5% by weight;
the ceramic is in the form of a CMC and, preferably, the matrix of said CMC is composed of oxides for more than 90%, preferably more than 95%, preferably more than 97%, preferably more than 98%, preferably more than 99%, preferably more than 99.5% by weight;
the matrix of the CMC is preferably composed substantially entirely of oxides;
said matrix comprises Al₂O₃and/or SiO₂and/or ZrO₂and/or Cr₂O₃;
the matrix of the CMC preferably comprises Al₂O₃and SiO₂;
in one embodiment, the Al₂O₃proportion in the matrix of the CMC, in percentage by weight based on the oxides of the matrix, is greater than 65%, preferably greater than 70%;
in one embodiment, the SiO₂proportion in the matrix of the CMC, in percentage by weight based on the oxides of the matrix, is greater than 15%, preferably greater than 20% and/or less than 35%, preferably less than 30%;
in one embodiment, the SiO₂proportion in the matrix of the CMC, in percentage by weight based on the oxides of the matrix, is greater than 60%, preferably greater than 70%; preferably greater than 80%;
in one embodiment, the proportion of oxides other than Al₂O₃ and SiO₂in the matrix of the CMC, in percentage by weight based on the oxides of the matrix, is less than 3%, preferably less than 2%, preferably less than 1%;
in one embodiment, the total Al₂O₃and SiO₂proportion in the matrix of the CMC is greater than 80%, preferably greater than 85%, preferably greater than 90%, preferably greater than 95%, in percentage by weight based on the oxides of the matrix;
in one embodiment, the silica of the matrix of the CMC is amorphous;
with preference, the ceramic, which is preferably in the form of a CMC, has a total SiO₂+Al₂O₃+ZrO₂+Cr₂O₃ proportion of greater than 80%, preferably greater than 85%, preferably greater than 90%, preferably greater than 95%, preferably greater than 97%, preferably greater than 97%. With further preference, the ceramic, which is preferably in the form of a CMC, has a total SiO₂+Al₂O₃ proportion of greater than 80%, preferably greater than 85%, preferably greater than 90%, preferably greater than 95%, preferably greater than 97%, preferably greater than 97%;
in a preferred embodiment, the ceramic, which is preferably in the form of a CMC, has the following chemical analysis, in percentage by weight based on the oxides, and for a total of 100%:
   SiO₂: 47%-67%,
   Al₂O₃: 32%-52%,
   oxide species other than Al₂O₃ and SiO₂: <5%, preferably <4%, preferably <3%, preferably <2%;
in one embodiment, the ceramic, which is preferably in the form of a CMC, is preferably amorphic, and has the following chemical analysis, in percentage by weight based on the oxides, and for a total of 100%:
   SiO₂: >95%, preferably >96%, preferably >97%, preferably >98%, preferably 99%;
the ceramic is in the form of a CMC and has a bulk density of greater than 1.0 g/cm³, preferably greater than 1.20 g/cm³, preferably greater than 1.40 g/cm³, or indeed greater than 1.50 g/cm³ and/or less than 2.00 g/cm³, preferably less than 1.90 g/cm³, preferably less than 1.80 g/cm³;
the ceramic is not in the form of a CMC and has a bulk density of greater than 1.80 g/cm³, or indeed greater than 2.00 g/cm³, and/or less than 3.20 g/cm³, preferably less than 3.00 g/cm³, preferably less than 2.80 g/cm³.

The shuttering is then installed by assembling these elements.

The installation of the interior shuttering is tricky, given the difficulty of access.

When they are being put in place, the shuttering elements can be held by a face which, in the use position, is exposed to the inside of the furnace, or by an opposite face.

At least one element of the interior shuttering made of CMC and/or one CMC accessory may be configured to be deformable between first and second configurations, the first configuration being designed for introduction into the furnace and the second configuration being designed for the use position. An element of the interior shuttering made of CMC and/or a CMC accessory may be foldable so as to be able to be introduced through the available access passages, for example a through-region to be repaired, or through access passages that can be created easily, for example by moving a burner.

With preference, at least some of the elements of the interior shuttering are made of a ceramic, preferably a CMC, which is configured to be foldable. These elements of the interior shuttering may for example comprise two rigid panels connected to one another by hinges. The hinges may be parts fixed to the two panels.

A shuttering element may also comprise multiple panels connected to one another by hinges made of a deformable refractory material, for example a prepreg.

After having been folded in order to be introduced into the furnace, the shuttering element is unfolded to give it the desired shape.

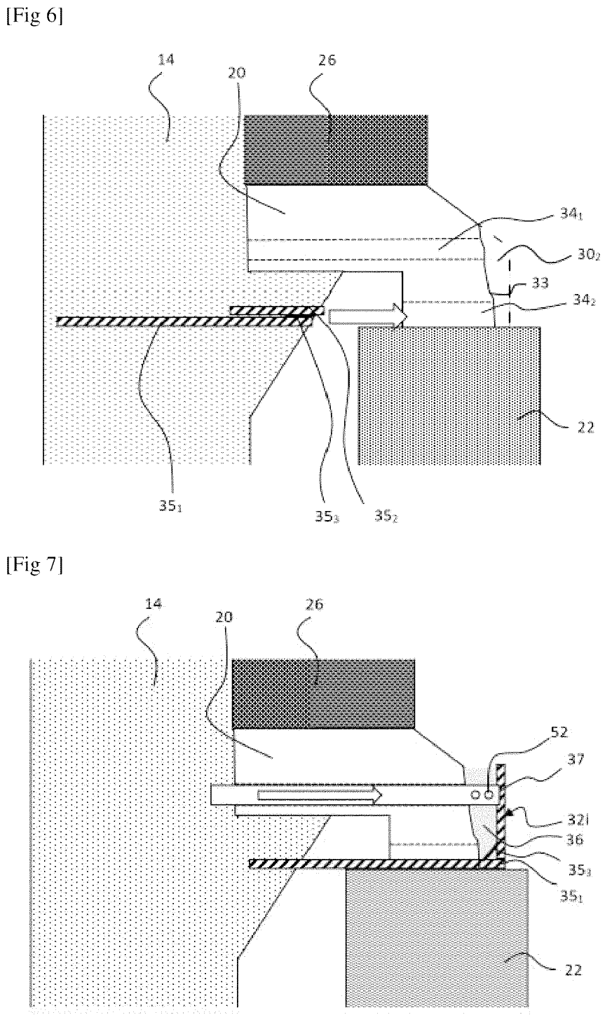

FIGS. 6 and 7 schematically illustrate the steps for installing a shuttering in order to reconstruct a tuckstone 20, in one embodiment.

FIG. 6 makes it possible to visualize the tuckstone in its state before repair, and in particular the zone of wear 33, which partially defines the inner surface of the furnace before the repair. The dashed line makes it possible to visualize the tuckstone in its new state.

Two passages, shown in dotted lines, have been formed in order to place the region to be repaired 30₂ in communication with the exterior of the furnace. The first passage 34₁ is cylindrical and configured for the introduction of a nozzle 50, which is described in more detail below. The second passage 34₂ has a substantially rectangular cross section and is configured for the introduction of a set of shuttering elements. The shuttering elements comprise first and second panels 35₁ and 35₂, respectively, and a hinge 35₃ connecting two adjacent edges of the first and second panels 35₁ and 35₂. By contrast to the panels, which are substantially non-deformable, the hinge is flexible. It is preferably made from a prepreg, which is to say a textile impregnated with a ceramic-matrix precursor, such that after sintering, the hinge is made of a CMC.

In FIG. 6, the first and second panels 35₁ and 35₂ are superposed one on the other via folding by means of the hinge. This compact configuration makes it easier to introduce them into the furnace, as illustrated by the arrow.

After the second panel 35₂ has been introduced, it is unfolded and positioned so as to follow the region to be repaired, as shown in FIG. 7. The shuttering elements then make up the shuttering 32 which, in this embodiment, comprises just one interior shuttering 32i. With part of the inner surface, the shuttering defines a mold 36 of which the interior volume, shown in gray in FIG. 6B, has a form similar to that of the region to be repaired.

The nozzle 50 is then introduced through the first passage 34₁, so as to lead out of the furnace and into the region to be repaired.

The nozzle preferably bears against the interior shuttering, preferably so as to contribute to holding the shuttering elements in position. That end of the nozzle that is introduced in the region to be repaired is preferably received in a recess 37 of complementary shape formed in the shuttering.

The repair product can then be introduced into the region to be repaired via the nozzle.

Numerous variants are possible. In particular,
the nozzle may be introduced into the furnace via a passage through which the shuttering elements were introduced into the furnace beforehand,
the shuttering elements may be introduced via a passage which leads into the furnace, but not into the region to be repaired,
it is possible for the nozzle to not be in contact with the shuttering,
the repair product may be introduced without using a nozzle, for example by casting the repair product through the top of the (open) mold in FIG. 6,
the nozzle may be introduced into the region to be repaired by passing through the shuttering, and optionally be anchored in a recess, preferably of complementary shape, formed in the inner surface of the furnace.

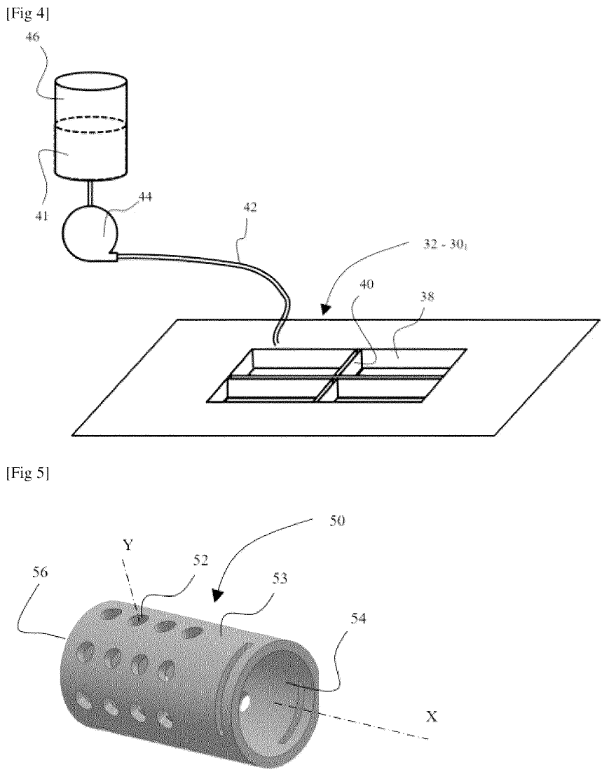

In one embodiment, as illustrated in FIG. 4, the region to be repaired is divided up into at least two compartments 38 by introducing one or more partitions 40. Notably, a partitioning makes it possible to limit the risk of stratification of the repair product, and results in the repair lasting for a longer period of time.

The partitioning is preferably determined such that each compartment has a base with a surface area less than or equal to 25 m², preferably less than 16 m², and/or greater than or equal to 3 m².

In one embodiment, the partitions of said compartments are made of a said ceramic, which is preferably in the form of a CMC.

In one embodiment, at least one element of the interior shuttering made of a ceramic, which is preferably in the form of a CMC, has through-holes and/or recesses. The filling of these holes and recesses by the repair product during step b) advantageously enables better immobilization of the interior shuttering and makes it possible to reduce the thermal gradient in the repair product during step 5). With preference, the mean equivalent diameter of the holes is greater than 8 mm and preferably less than 20 mm, preferably less than 15 mm.

In one embodiment, said shuttering element made of a ceramic, which is preferably in the form of a CMC, is in the form of a grid, the holes being preferably distributed uniformly, the total surface area of the holes representing more than 10%, preferably more than 15% and preferably less than 50%, preferably less than 40% of the inside surface area of said shuttering element, which is to say the surface area that contributes to defining the mold around the region to be repaired (surface area of the holes and of the material of the grid).

In one embodiment, said holes are located in the lower two thirds of said shuttering element and are preferably distributed evenly. With further preference in said embodiment, the total surface area of the holes represents more than 1% and less than 5% of the inside surface area of said shuttering element (surface area of the holes and of the material of said shuttering element).

The through-holes and/or the recesses can be made by any technique known to those skilled in the art. In particular, through-holes can be made by drilling or waterjet cutting, for example on the ceramic, which is preferably in the form of a CMC, obtained after sintering. In a CMC, the through-holes and/or recesses can also be made in the textile, which is preferably a woven fabric, before the latter is coated with the slurry.

Accessories are then conventionally used to hold the shuttering elements in the use position.

In one embodiment, the leaktightness between the interior shuttering and the inner surface of the furnace is increased by disposing a mat of ceramic fibers between said interior shuttering and said surface.

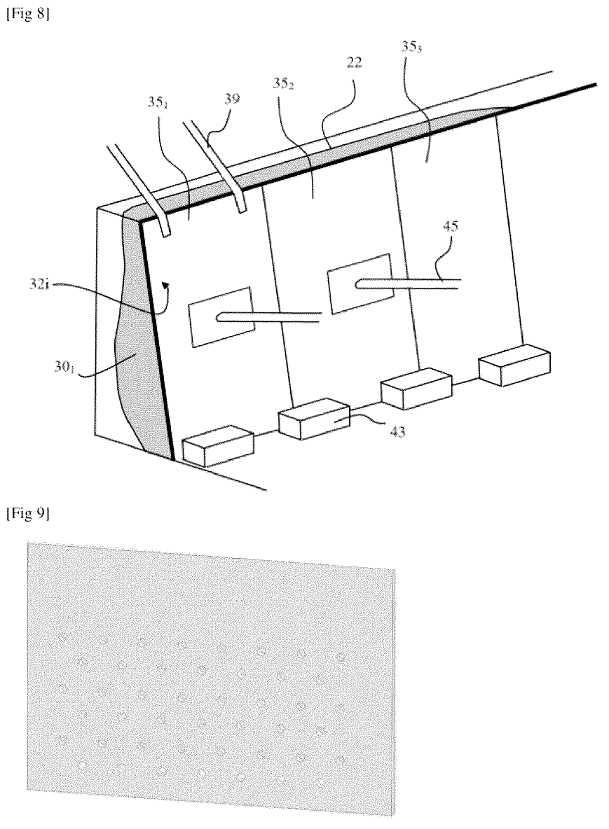

FIG. 8 illustrates an example of interior shuttering according to the invention. What is shown in particular is the interior shuttering 32i, and in particular 3 adjacent panels 35₁ and 35₂ and 35₃, which are held in position by means of metal clamps 39, chocks 43 and cooled tubes 45.

In step b), the mold delimiting the region to be repaired is filled with a repair product, preferably by casting.

### Repair Product

The repair product may be a conventional repair product and may be prepared by any known technique.

The repair product is preferably the result of wetting an unshaped product. Said wetting may be carried out by any known technique, for example in a kneader. Those skilled in the art will know to determine the amount of solvent, preferably water, to use in order to wet the unshaped product and obtain the repair product.

The unshaped product may be in particular:
Repair Hot Bottom AZS, in particular when the region to be repaired is located on the floor of the tank of the furnace,
Repair Hot Overcoat AZS, Repair Hot Overcoat Alumina or Repair Hot Overcoat Chrom50, in particular when the region to be repaired is located on a wall of the tank of the furnace, or
Repair Hot Overcoat Fused Silica when the region to be repaired is located at the crown.

These unshaped products are sold by Saint-Gobain Sefpro.

With preference, the maximum size of the particles of the repair product or, equivalently, of the unshaped product is less than 10 mm, preferably less than 8 mm, preferably less than 6 mm.

The grain size distribution of the repair product or, equivalently, of the unshaped product is preferably determined such that the repair product is self-flowable under hot conditions.

With preference, the repair product is selected so as to have a chemical analysis very close to that of the material of the furnace that delimits the region to be repaired, preferably such that the proportion of any constituent of the repair product differs by less than 10% from the proportion of said constituent in said material.

For example, if the region to be repaired is delimited by one or more refractory blocks made of an AZE (Alumina-Zirconia-Silica) product, the unshaped product for manufacturing the repair product is preferably Repair Hot Bottom AZS or Repair Hot Overcoat AZS, depending on the location of the region to be repaired in the glass melting furnace. If the region to be repaired is delimited by one or more refractory blocks made of an AZS-chromium product, the unshaped product for manufacturing the repair product is preferably Repair Hot Overcoat Chrom50.Lastly, if the region to be repaired is delimited by one or more refractory blocks made of a silica product, the unshaped product for manufacturing the repair product is preferably Repair Hot Overcoat Fused Silica.

The repair product can be brought up to the region to be repaired using any technique known to those skilled in the art.

If the region to be repaired is difficult to access, one or more passages, for example made by drilling, can be formed from the outside to the inside of the furnace. These passages advantageously make it possible to introduce means for conveying the repair product, for example a cooled rod or a nozzle, up to the region to be repaired.

In one embodiment, the repair product is pumped by means of a pump generating a suction pressure preferably less than or equal to 180 bar and is preferably delivered to the region to be repaired by means of a water-cooled rod or a nozzle.

In one embodiment, the repair product is supplied ready for use, which is to say stored in an already-wetted state. Advantageously, the rate at which the region to be repaired is filled can be increased and/or the number or the capacity of the pumps can be reduced.

Throughout step b), the region to be repaired is preferably kept at a temperature higher than 300° C., preferably higher than 400° C., preferably higher than 500° C., preferably higher than 600° C., preferably higher than 700° C., preferably higher than 800° C., preferably higher than 900° C., and/or preferably lower than 1550° C., preferably lower than 1500° C.

### Nozzle

As illustrated in FIG. 4, the repair product 41 is conventionally delivered to the region to be repaired via a tubular pipe 42 or a channel, of which a first end is connected to the outlet of the pump 44 supplied by a reservoir 46 of repair product, and of which a second end is free, or connected to a nozzle 50, preferably introduced and fixed in the region to be repaired, preferably fixed to the interior shuttering and/or on the inner surface of the furnace, and in particular on that part of the inner surface that delimits the region to be repaired.

The nozzle is intended to distribute the repair product, but also, preferably, serves for anchoring in the cast repair product, and/or contributes to holding the interior shuttering in position. The nozzle preferably contributes to holding the interior shuttering in position after the repair product has hardened.

When the repair product comes out of the second end or out of the nozzle 50, it is subjected to a sudden rise in the temperature of its surrounding area, and this in particular results in a reduction in its ability to flow. In order that the repair product is distributed uniformly, the number of nozzles can be multiplied.

The inventors have discovered that it was advantageous for the repair product to be able to come out radially, preferably on all sides and preferably over the entire length of the nozzle.

FIG. 5 illustrates a non-limiting embodiment of a nozzle 50 in a preferred embodiment of the invention.

The nozzle 50 has the overall form of a cylindrical sleeve with a circular base, of axis X. The nozzle has a supply orifice 54, of axis X, through which the repair product enters the nozzle. The axis X is therefore the supply direction of the nozzle.

Two circumferential through-recesses 58, intended for fixing the nozzle, are shown at the supply orifice 54.

At the opposite end to the supply orifice, the nozzle preferably has an end wall 56. During the injection of the repair product, the end wall 56 preferably extends substantially horizontally, the direction of the length of the nozzle therefore being vertical.

The sleeve has a wall of substantially constant thickness, preferably greater than 5 mm, preferably greater than 7 mm, preferably greater than 10 mm and preferably greater than 30 mm, preferably less than 25 mm, preferably less than 20 mm. Its equivalent inside diameter is preferably greater than 40 mm and preferably less than 200 mm, preferably less than 150 mm, preferably less than 100 mm.

The length of the nozzle is determined on the basis of the shape of the region to be repaired. It may in particular range between 1 and 10 times the equivalent inside diameter of the sleeve.

The side wall of the nozzle has a plurality of discharge orifices 52 each emerging, over the outer surface 53 of the nozzle, via a respective discharge opening of axis Y extending radially, which is to say intersecting the axis X, perpendicularly to the axis X. The nozzle preferably has more than 1, preferably more than 3, preferably more than 5, preferably more than 10, preferably more than 20 and/or less than 100, preferably less than 50 discharge orifices 52, which are identical or different.

The discharge orifices 52 are preferably circumferentially evenly distributed. Along a circle of axis X which intersects a discharge orifice 52, preferably along each circle of axis X which intersects a discharge orifice 52, discharge orifices 52 are evenly distributed. The discharge orifices intersected by one and the same circle of axis X form a “row” of discharge orifices 52.

The discharge orifices 52 are preferably evenly distributed along a direction parallel to the axis X, which is to say along the direction of the length of the nozzle. Along this direction, the nozzle preferably has more than 1, preferably more than 2, preferably more than 3 and/or less than 10,preferably less than 8, preferably less than 5 rows of discharge orifices 52. The nozzle in FIG. 5 has 4 such rows.

All of the discharge orifices 52 thus preferably form a regular pattern. This further improves the uniformity of the distribution of the repair product.

With preference, each discharge orifice is a cylindrical hole, preferably of circular or oblong, preferably circular cross section. The discharge openings of the ejection orifices, on the outer surface of the sleeve, are preferably evenly distributed over this outer surface. This improves the uniformity of the distribution of the repair product.

With further preference, the discharge opening of a discharge orifice, preferably of each discharge orifice, has an equivalent diameter greater than 8 mm, preferably greater than 10 mm and less than 50 mm, preferably less than 40 mm, preferably less than 30 mm, preferably less than 25 mm.

The nozzle is preferably formed in one piece.

With preference, it is made of a ceramic, preferably sintered. With preference, its chemical composition is similar, preferably identical to that of the repair product. With preference, the proportion of any constituent of the repair product present in an amount greater than 5% by weight differs by less than 20%, preferably less than 10% of the proportion of said constituent in the nozzle. Advantageously, the nozzle can be left in the region to be repaired after said region to be repaired has been filled with repair product, without its presence causing composition to lack uniformity in said region to be repaired.

In step 5), which is optional, and in particular if the method comprises a step 3), the furnace is kept at a temperature ranging between 900° C. and 1400° C., preferably between 1250° C. and 1400° C., preferably between 1300° C. and 1400° C., in order to make it possible to sinter the repair product, preferably for a duration longer than 8 hours, preferably longer than 10 hours and preferably shorter than 15 hours.

In step 6), normal operation of the furnace is resumed: A composition of glass to be melted is introduced into the furnace and, if said method comprises a step 3), the temperature of the furnace is increased in order to resume operation of the furnace.

### EXAMPLES

The non-limiting examples which will follow are given for the purpose of illustrating the invention.

In a first particular embodiment, in particular when the region to be repaired is located in the superstructure of the glass melting furnace, the interior shuttering is made of a ceramic, which is preferably in the form of a CMC, preferably of one or more plates made of a ceramic, which is preferably in the form of a CMC, that are preferably held against the sound superstructure part using one or more metallic rods preferably cooled by means of water circulation. If the region to be repaired leads to the exterior of the furnace, a plating constituting the exterior shuttering and preferably made of a ceramic, which is preferably in the form of a CMC, is fixed so as to externally shut off the region to be repaired.

The region to be repaired is then filled with the repair product. The repair product is preferably delivered, from the exterior of the furnace, via a pipe passing through one or more passages formed through the outer wall of the furnace, then cast into the region to be repaired through at least one nozzle according to the invention, which nozzle is preferably disposed in the region to be repaired.

The one or more nozzles are made of a ceramic material with a chemical composition which is preferably similar, preferably identical to that of the repair product.

With preference, the shuttering made of a ceramic, which is preferably in the form of a CMC, and/or the one or more nozzles are not removed after the repair product has been put in place.

In a second particular embodiment, in particular when the region to be repaired is located at the tuckstones, those parts of the tuckstones that have disappeared during use of the furnace are replaced by the repair product. The shuttering comprises, preferably is made up of plates made of a ceramic, which is preferably in the form of a CMC, that are arranged so as to at least partially recreate the shape of a new tuckstone. The one or more shuttering elements are preferably introduced into the furnace in the folded state and are then unfolded and fixed so as to delimit the region to be repaired. In one embodiment, the region to be repaired, which is delimited by the shuttering made of a ceramic, which is preferably in the form of a CMC, is filled with repair product via the interior of the furnace. In one embodiment, the region to be repaired, which is delimited by the shuttering made of a ceramic, which is preferably in the form of a CMC, is filled with repair product via the exterior of the furnace.

In a third particular embodiment, in particular when the region to be repaired results from wear of the tank of the furnace, the molten glass is at least partially drained. The interior shuttering is made of a ceramic, which is preferably in the form of a CMC, preferably of one or more plates made of a ceramic, which is preferably in the form of a CMC, that are preferably held against the tank using one or more tubes made of a ceramic, which is preferably in the form of a CMC, and/or one or more metallic rods, which are preferably cooled by means of water circulation. If the region to be repaired leads to the exterior of the furnace, a plating constituting the exterior shuttering and preferably made of a ceramic, which is preferably in the form of a CMC, is fixed so as to externally shut off the region to be repaired.

The region to be repaired is then filled with the repair product. The repair product is preferably delivered, from the exterior of the furnace, via a pipe passing through one or more passages formed through the enclosure of the furnace, then cast into the region to be repaired through at least one nozzle according to the invention, which nozzle is preferably disposed in the region to be repaired.

The one or more nozzles are made of a ceramic material, which is preferably selected as a material having a chemical composition which is similar, preferably identical to that of the repair product.

With preference, the shuttering made of a ceramic, which is preferably in the form of a CMC, and/or the one or more nozzles are not removed after the repair product has been put in place.

In a preferred embodiment, the elements of the interior shuttering, the optional partitions disposed in the region to be repaired, and the accessories used for the assembly of these elements and of these partitions are not removed after the repair product has been put in place.

Two examples have been realized with the same repair product, these examples differing in the rate at which the repair product rises in the mold.

To manufacture the repair product, the unshaped product Repair Hot Overcoat AZS, sold by Saint-Gobain Sefpro, was mixed with 10%, in percentage by weight based on the unshaped product, of a solution of colloidal silica of concentration equal to 20% for 5 minutes in a kneader having a rotary blade and a stationary tank.

The unshaped product had the following composition by weight, based on the weight of the oxides of the unshaped product:
Al₂O₃: 56%,
SiO₂: 8%,
ZrO₂: 35%,
other oxides: 1%.

250 kg of repair product were prepared. This repair product was self-flowable under hot conditions.

For each example, a one-piece mold made of a CMC was produced.

This mold had a rectangular parallelepipedal overall shape with a flat base having a length equal to 600 mm and a width equal to 150 mm, and side walls extending from the periphery of the base over a height equal to 450 mm, the thickness of the walls of said mold being substantially constant and equal to 10 mm.

The constituent CMC of the two molds had a thermal conductivity between 20° C. and 500° C. of less than 0.6 W·m⁻¹·K⁻¹.

The CMC was made up of:
a superposition of woven fabrics made of leached glass fibers comprising a silica proportion greater than 90% by weight, representing 44% of the mass of the CMC, and
a matrix made of alumina and silica, representing 56% of the mass of the CMC.

Said CMC had an open porosity equal to 38%, a bulk density equal to 1.65 g/cm³, an Al₂O₃ proportion equal to 42%, a SiO₂proportion equal to 57% and a proportion of other oxides equal to 1%, the proportions of Al₂O₃, SiO₂ and other oxides being expressed in percentages by weight based on the oxides of said CMC.

The two molds were disposed in a furnace comprising a gas burner.

The furnace was then started up so as to reach a temperature of 1200° C. in 2 hours and 40 minutes, simulating an introduction of the molds made of CMC into a glass furnace under hot conditions. Then, the temperature was brought to 1500° C., the rate of temperature increase between 1200° C. and 1500° C. being equal to 35° C./h.

The repair product was cast into each mold, kept at 1500° C., by means of a metallic channel disposed above an opening made in the crown of the furnace.

For example 1 according to the invention, the repair product was cast continuously, with a flow rate substantially equal to 100 kg/min, and for example 2 according to the invention, the repair product was cast continuously, with a flow rate substantially equal to 300 kg/min.

During the filling, it was noted that the molds made of CMC withstand the surge of the repair product without breaking or opening.

After having filled the molds, the temperature was kept at 1500° C. for 24 hours. The temperature was then reduced gradually down to 800° C., at a rate substantially equal to 25° C./h. Then, the burner was stopped and the temperature was allowed to drop naturally, without opening the furnace.

The inventors consider that this test reproduces the conditions encountered during a repair of a furnace tank part well.

The sintered repair products located in each of the molds were then recovered.

After sawing, they had a uniform texture, without cracks or internal cavities that might correspond to an interruption in supply.

Similar tests can be performed with a one-piece mold of the same dimensions as the mold made of CMC described above, made of a ceramic of the same composition as the CMC but obtained by casting a slurry into a mold of suitable shape, without incorporation of fibers, and then sintering.

The results obtained with such a one-piece mold which is cast (not in the form of a CMC) are similar to those obtained with the mold made of a CMC that was tested previously.

As is presently clearly apparent, the invention thus provides a method for hot repair of a glass melting furnace that makes use of elements made of a ceramic, which is preferably in the form of a CMC, to produce the interior shuttering, and this:
enables quick manufacture perfectly suited to the region to be repaired, in particular because a ceramic, which is preferably in the form of a CMC, can be shaped into complex shapes, and in particular so as to closely follow the profile of the region to be repaired;
makes it easier to introduce these elements into the furnace, in particular when these elements are folded in order to be introduced via narrow passages through the furnace;
makes these elements easier to arrange, since they are lightweight and can be unfolded elastically;
allows the shuttering element to be sacrificed, which is to say retained in the furnace after the repair, in particular because the composition of a ceramic, which is preferably in the form of a CMC, can be selected to be similar to that of the repair product.

A nozzle according to the invention furthermore makes it possible:
to cast the repair product simultaneously in multiple directions and at different heights, and this enables quick filling of the region to be repaired, but also makes it possible to obtain a uniform distribution without layers;
to sacrifice the nozzle when its chemical composition is selected to be similar to that of the repair product.

Of course, the present invention is not limited to the embodiments described or shown, which are provided by way of illustrative and non-limiting examples.

In particular, the compositions of the ceramics and/or the structures of the CMCs of the various parts of the shuttering and/or of the nozzle and/or of the accessories may be identical or different.

1. A method for hot repair of a region to be repaired on the inside of a glass melting furnace,
said furnace having:
a tank intended to contain the molten glass and having a floor defining a substantially horizontal bottom of the tank and a vertical side wall encircling the bottom,
a metallic structure, and
a superstructure intended to close the furnace by covering the tank and resting on the metallic structure,
the region to be repaired being at a temperature higher than 300° C., said method comprising the following steps:
a) installing an interior shuttering in a use position, so as to produce a mold around the region to be repaired;
b) filling the mold with a repair product,
the interior shuttering having components that come into contact with the repair material during the repair, referred to as “shuttering elements”,
all the shuttering elements being made of a ceramic,
the region to be repaired being located in the side wall of the tank and/or in the superstructure.

2. The method as claimed in claim 1, wherein step a) involves introducing into the furnace, through a passage, at least one element of said interior shuttering in a first configuration, and then deploying said shuttering element from the first configuration into a second configuration that is incompatible with an extraction of said shuttering element through said passage.

3. The method as claimed in claim 2, wherein said shuttering element is folded in the first configuration, and unfolded in the second configuration.

4. The method as claimed in claim 2, wherein the passage results from wear of the furnace.

5. The method as claimed in claim 1, wherein at least one element of said interior shuttering has the form of a part of the furnace that protruded into the furnace before said part disappeared owing to wear.

6. The method as claimed in claim 5, wherein the element of said interior shuttering has the form of a surface of a tuckstone delimiting the interior of the furnace before said wear.

7. The method as claimed in claim 1, wherein the manufacture of said part of the interior shuttering includes taking an impression on a replica of that part of the furnace comprising the region to be repaired, before the wear of the furnace having resulted in the region to be repaired.

8. The method as claimed in claim 1, wherein step b) involves filling the mold by causing the repair product to pass through a nozzle, provided with discharge orifices which are radial with respect to a supply direction of the nozzle.

9. The method as claimed in claim 8, wherein
a first end of the nozzle bears against a surface of the interior shuttering, a second end of the nozzle being on the outside of the region to be repaired, or
a first end of the nozzle bears against a inner surface of the furnace that defines the region to be repaired, a second end of the nozzle being on the outside of the region to be repaired.

10. The method as claimed in claim 8, wherein the nozzle is made of a ceramic.

11. The method as claimed in claim 1, comprising, after step b), a step 5) of sintering the repair product introduced into the mold in step b), the sintered repair product obtained including a plurality of constituents, the proportion of any constituent of the sintered repair product present in a proportion of greater than 5%,
differing by less than 20% from the proportion of said constituent in said ceramic, and/or
differing by less than 20% from the proportion of said constituent in a region of the furnace that delimits the region to be repaired, and/or
when one of claims 8 to 10 applies, differing by less than 20% of the proportion of said constituent in said nozzle,
the proportions being given as percentages by weight based on the oxides.

12. The method as claimed in claim 1, wherein the interior shuttering and/or, when step b) involves filling the mold by causing the repair product to pass through a nozzle, provided with discharge orifices which are radial with respect to a supply direction of the nozzle, the nozzle are discarded in the region to be repaired after said repair.

13. The method as claimed in claim 1, wherein the interior shuttering is entirely made of a ceramic.

14. The method as claimed in claim 1, wherein at least one said element of the interior shuttering made of a ceramic has through-holes and/or recesses disposed so as to be filled by the repair product during step b).

15. The method as claimed in claim 1, wherein at least one said shuttering element has the form of a flat or non-flat plate, the thickness of the plate being greater than 3 mm and less than 50 mm.

16. The method as claimed in claim 1, wherein the interior shuttering has accessories for holding said shuttering elements in a use position,
said accessories being made of a ceramic which is identical to or different than the ceramic of the shuttering elements.

17. The method as claimed in claim 1, wherein the ceramic of said shuttering elements and/or, when the nozzle is made of a ceramic, the ceramic of said nozzle, and/or, when the interior shuttering has accessories for holding said shuttering elements in a use position, the ceramic of at least one accessory
is (are) sintered, and/or
has (have) an open porosity greater than 10% and less than 30%, and/or
includes (include) of oxides for more than 90% of its weight, and/or
has (have) a bulk density greater than 1.8 g/cm³ and less than 3.2 g/cm³, and/or
has (have) a total SiO₂+Al₂O₃+ZrO₂+Cr₂O₃ proportion of greater than 80%, in percentage by weight based on the oxides.

18. The method as claimed in claim 1, said method comprising,
before step a), the following step:
if the region to be repaired is, at least partially, delimited by a surface of the tank of the furnace that is in contact with the bath of molten glass, at least partially draining said molten glass from the tank so as to expose said region to be repaired;
and, after step b), the following step:
introducing a glass composition to be melted into the tank,
the temperature of the furnace being maintained in said region to be repaired throughout the steps of the method.

19. The method as claimed in claim 1, said method comprising, before step a), the following steps:
1) if the region to be repaired is, at least partially, delimited by a surface of the tank of the furnace that is in contact with the bath of molten glass, at least partially draining said molten glass from the tank so as to expose said region to be repaired;
3) reducing the temperature in the furnace to a temperature higher than 300° C.;
and, after step b), the following steps:
5) increasing and maintaining the temperature of the furnace between 900° C. and 1400° C. in order to sinter the repair product;
6) introducing a glass composition to be melted into the tank and increasing the temperature of the furnace up to an operating temperature resulting in the melting of said composition.

20. The method as claimed in claim 19, wherein, in step 3), the temperature in the furnace is reduced to a temperature higher than 900° C. and lower than 1500° C.

21. The method as claimed in claim 18, comprising, after exposing the region to be repaired, a step of rinsing the region to be repaired.

22. The method as claimed in claim 1, wherein the interior shuttering comprises panels made of a ceramic, which are connected to one another by at least one hinge made of a CMC.

23. The method as claimed in claim 1, wherein the weight of more than 50% by number of the shuttering elements is greater than 3 kg and less than 50 kg, and/or wherein the largest dimension of more than 30% by number of the shuttering elements is greater than 400 mm and less than 1600 mm.

24. A glass melting furnace comprising at least one region repaired by a method as claimed in claim 1.
